(19) United States
(12) Patent Application Publication
(10) Pub. No.: US 2010/0321511 A1
(43) Pub. Date: Dec. 23, 2010

(54) Lenslet camera with rotated sensors

(75) Inventors: Samu T. Koskinen, Tampere (FI); Juha H. Alakarhu, Helsinki (FI); Eero Salmelin, Tampere (FI)

Correspondence Address: HARRINGTON & SMITH, 4 RESEARCH DRIVE, Suite 202, SHELTON, CT, 06484-6212, US

(73) Assignee: Nokia Corporation

(21) Appl. No.: 12/456,543

(22) Filed: Jun. 18, 2009

(51) Int. Cl. H04N 5/225; H04N 5/335

(52) U.S. Cl. 348/218.1; 348/E05.024; 348/311; 348/E05.091

(57) ABSTRACT

At a digital imaging system, a first set of samples of a scene are digitally captured with a first array of image sensing nodes while simultaneously a second set of samples of the scene are digitally captured with a second array of image sensing nodes. Image sensing nodes of the second array are oriented in a rotated position relative to the image sensing nodes of the first array. The first and second sets of samples are integrated with one another while correcting for the rotated orientation of the image sensing nodes of the second array relative to the image sensing nodes of the first array, and from that integration is output a high resolution image. In specific embodiments, there may be additional arrays of image sensing nodes, different arrays may sample different size portions of the scene, and be also rotated relative to other sensing node arrays.

### TECHNICAL FIELD

The exemplary and non-limiting embodiments of this invention relate generally to digital imaging devices such as digital cameras having one or more arrays of image sensors and corresponding lenslets.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Digital imaging can be broken into two main categories. Complementary metal-oxide semiconductor CMOS technology uses an array of pixels whose outputs are read out by an integrated circuit. Often this read-out circuit and the pixel array are made as one semiconductor device, and together they are termed an image sensor. Each pixel contains a photodetector and possibly an amplifier. There are many types of such active pixel sensors, and CMOS is the technology commonly used in mobile phone cameras, web cameras, and some digital single-lens reflex camera systems. The other main category is a charge coupled device CCD which uses an array of diodes, typically embodied as an array of p-n junctions on a semiconductor chip. Analog signals at these diodes are integrated at one or chains of capacitors and the signal is also processed by a read-out circuit, and the capacitor arrangements may be within the readout circuit. Often, the term pixel is used generically, referring to both an active sensor pixel of CMOS devices and to a diode junction of a CCD system. The term ‘image sensing node’ is used herein generically for an individual image capturing element, and includes a CMOS pixel, a CCD diode junction, and individual image capture nodes of other technologies now available or yet to be developed.

Digital imaging systems (cameras) use an array of image sensing nodes aligned behind an array of lenslets which focus light onto the image sensing nodes. Each image sensing node has a corresponding lenslet, though this does not always mean a one-to-one correspondence of lenslet to image sensing node. It is known to use multiple arrays of image sensing nodes to improve resolution. For example, some commercial embodiments of this include multiple charge-coupled devices CCD, in which each CCD is a separate diode array and the multiple CCDs each image the scene simultaneously. For CMOS implementations, the different image sensing node arrays may be different image sensors disposed adjacent to one another behind the system aperture. There may be a single lenslet array for the multiple sensor arrays or a separate lenslet array corresponding to each sensor array.

Whatever the underlying image-capture technology, the lower resolution output of each of these different arrays is integrated into a higher resolution image by a super resolution algorithm. For example, one particular imaging system may have four arrays of image sensing nodes, each with a 2 MP (mega-pixel) resolution capacity, so that in the ideal the super resolution algorithm can generate from those four lower resolution images that are input to it a single 8 MP image.

Note that the above characterization is in the ideal. The super resolution algorithms work well if the arrays of image sensing nodes are aligned so that the system nodes are sampling at as high a frequency as possible. Super resolution algorithms rely on perfectly aligned sets of image sensing nodes. But for the case where the nodes are not correctly aligned with one another, the portion of the scene that the mis-aligned nodes captures overlaps, and the extent of the overlap represents oversampling of the scene and a reduction from a theoretical maximum resolution that the super resolution algorithm might otherwise generate. For example, if a CMOS system had two pixel arrays of 2 MP each and they were perfectly aligned, the resultant image from the super resolution algorithm would be 4 MP. With a 25% overlap due to pixel array mis-alignment, the final image would have a resolution of 3.5 MP (since 25% of the image captured by one pixel array is identical to that captured by the other array and so cannot add to resolution). This alone understates the true amount of resolution reduction. If we assume that perfect alignment would have each pixel imaging a separate and non-overlapping portion of the scene, the 25% overlap necessarily means that there is 25% of the scene imaged by one of the pixel arrays, or 12.5% of the entire scene, that is never captured. This is because the amount of the sample overlap with other pixels directly diminishes what is captured from the scene itself, since perfect alignment would have no overlap in the image captured by individual pixels. Thus while the resultant image may in fact be 3.5 MP, there are 12.5% discontinuities at the pixel level which occur during scene capture. Typically these are resolved by smoothing software before the final image is output for viewing by a user.

The above problem arises because it is very difficult to achieve perfectly accurate sub pixel alignment accuracies due to mechanical tolerances. In practical implementation, during mass production of a population of end-user imaging systems there would be a distribution of image resolution output by the different units of that population. To assume an extreme example, assume a population of four camera lenslet systems in which the best units have perfect alignment and the worst units have 100% overlap of all four lenslet systems. Those best units then have four times higher resolution than the worst systems, even though their underlying design and manufacturing processes are identical.

### SUMMARY

The foregoing and other problems are overcome, and other advantages are realized, by the use of the exemplary embodiments of this invention.

In a first exemplary and non-limiting aspect of this invention there is a method which comprises: digitally capturing a first set of samples of a scene with a first array of image sensing nodes while simultaneously digitally capturing a second set of samples of the scene with a second array of image sensing nodes. The image sensing nodes of the second array are oriented in a rotated position relative to the image sensing nodes of the first array. Further in the method, the first and second sets of samples are integrated with one another while correcting for the rotated orientation of the image sensing nodes of the second array relative to the image sensing nodes of the first array, and a high resolution image is output.

In a second exemplary and non-limiting aspect of this invention there is an apparatus comprising: at least a first array of image sensing nodes and a second array of image sensing nodes. The second array of image sensing nodes is oriented in a rotated position relative to the image sensing nodes of the first array. The apparatus further comprises at least one array of lenslets disposed to direct light from external of the apparatus toward the first and second arrays. The apparatus also comprises a memory storing a program that integrates outputs of the first and second arrays to a high resolution image while correcting for the rotated orientation of the image sensing nodes of the second array relative to the image sensing nodes of the first array. And this particular embodiment of the apparatus comprises also at least one processor that is configured to execute the stored program on outputs of the first and second arrays.

In a third exemplary and non-limiting aspect of this invention there is a computer readable memory storing a program of executable instructions. When executed by a processor the program result in actions comprising: digitally capturing a first set of samples of a scene with a first array of image sensing nodes while simultaneously digitally capturing a second set of samples of the scene with a second array of image sensing nodes. The image sensing nodes of the second array are oriented in a rotated position relative to the image sensing nodes of the first array. The actions further comprise integrating the first and second sets of samples with one another while correcting for the rotated orientation of the image sensing nodes of the second array relative to the image sensing nodes of the first array, and outputting a high resolution image.

### BRIEF DESCRIPTION OF THE DRAWINGS

FIG. 1 is a high level schematic diagram showing arrangement of read-out circuit, pixels and lenslets with respect to a scene being imaged.

FIG. 2 is a schematic diagram illustrating different color photosensors within a pixel array.

FIGS. 3A-C illustrate conceptually the pixel mis-alignment problem.

FIGS. 4A-4B illustrate conceptually two example embodiments of the present invention which minimize the mis-alignment problem of the prior art.

FIG. 5 is a schematic diagram of a pixel array relative to a scene being imaged according to an example embodiment of the invention.

FIG. 6 is a schematic diagram showing relative orientation of four pixel arrays in a host device, and exaggerated portions of a scene captured by a single pixel of each of the arrays.

FIG. 7 shows a more particularized block diagram of a user equipment embodying a camera with pixel arrays arranged according to an exemplary embodiment of the invention and a corresponding super resolution algorithm stored in a memory of the user equipment.

FIG. 8 is a logic flow diagram that illustrates the operation of a method, and a result of execution of computer program instructions embodied on a computer readable memory, in accordance with the exemplary embodiments of this invention.

### DETAILED DESCRIPTION

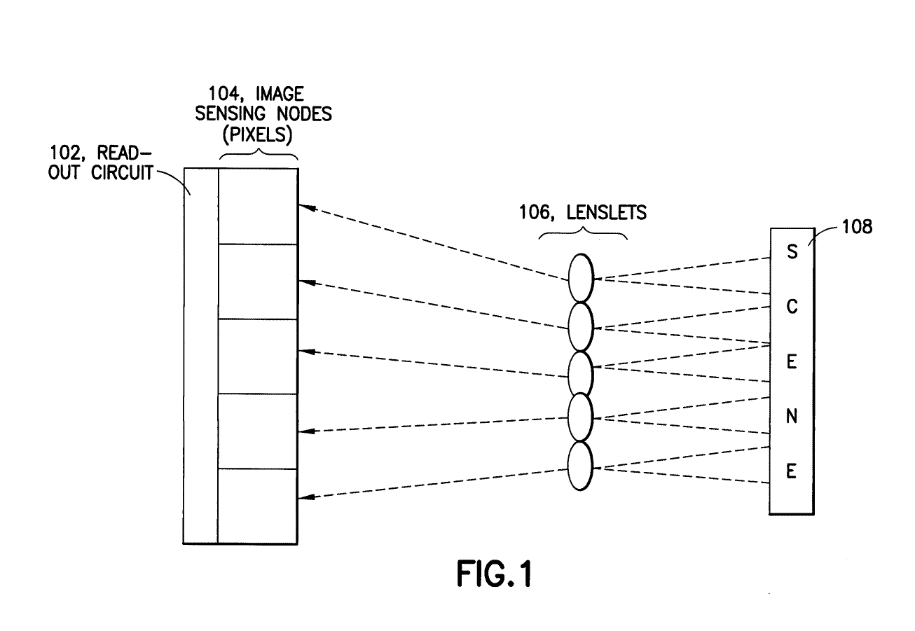

FIG. 1 is a high level schematic diagram showing arrangement of read-out circuit 102, one row of an array of image sensing nodes 104 (specifically, pixels of a CMOS array) and a corresponding row of an array of lenslets 106. The lenslets define the system aperture, and focus light from the scene 108 being imaged to the surface of the photoconducting pixels 104. Typically the array of image sensing nodes 104 and the array of lenslets 106 are rectilinear, each being arranged in rows and columns. FIG. 1 illustrates one lenslet 106 corresponding to one pixel 104 but in some embodiments one lenslet may correspond to more than one pixel. The array of image sensing nodes 104 and/or the array of lenslets 106 may be planar as shown or curved to account for optical effects.

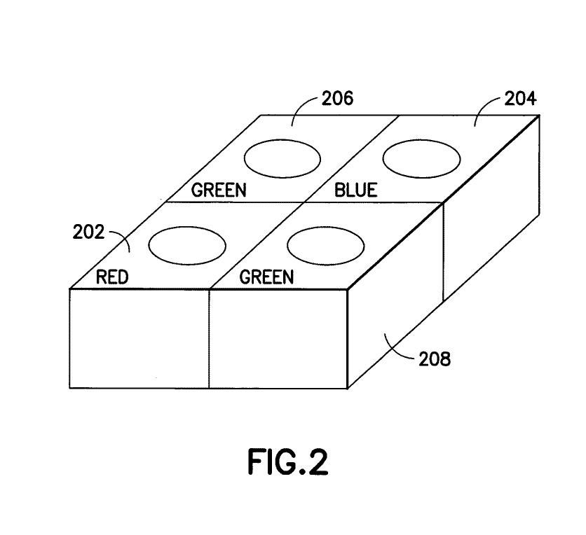

FIG. 2 shows an example embodiment of an imaging system in which there are four parallel cameras 202, 204, 206, 208 which image red, blue and green from the target scene. These parallel cameras each have an array of lenslets and an array of image sensing nodes. In some embodiments there may be a single read-out circuit on which each of the four image sensing node arrays are disposed (e.g., a common CMOS substrate), or each of the image sensing node arrays may have its own read-out circuit and the four cameras are each stand-alone imaging systems whose individual outputs are combined and integrated via software such as a super resolution algorithm to result in a single higher resolution image which is output to a computer readable memory or to a graphical display for viewing by a user.

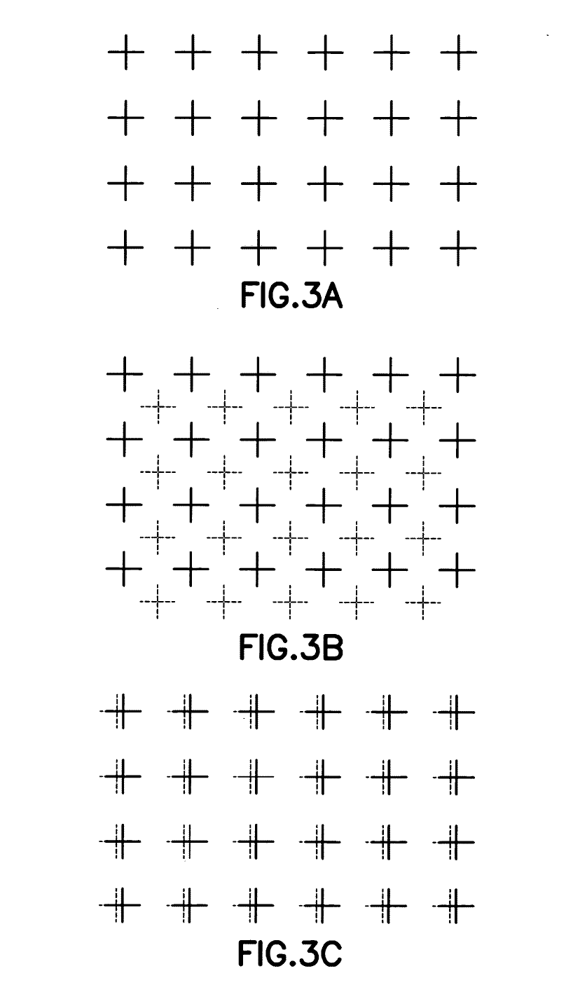

FIGS. 3A-C illustrate the alignment problem for imaging systems with multiple arrays of image sensing nodes such as is shown at FIG. 2. Each + at FIGS. 3A-C represents a center of focus of a portion of the scene imaged by an individual image sensing node. For example, the scene 108 of FIG. 1 is shown in side view but FIG. 3A shows the scene as viewed from the array of lenslets 106. One might consider that a generally circular area centered on each + at FIG. 3A is the portion of the overall scene which is captured by any individual image sensing node that corresponds to that portion. It is known in the visible wavelength imaging arts that the size of such a circular area which can be reliably captured is limited, as a function of focal distance. Physical spacing of the individual image sensing nodes in the array is therefore a function of focal length as well as economics (more image sensing nodes are more costly to manufacture).

FIG. 3B illustrates similar to FIG. 3A but for a two-array imaging system. Center-points corresponding to individual image sensing nodes of one array are shown as a solid line +, and center-points corresponding to individual image sensing nodes of the other array are shown as a dashed line +. The center-points, and thus the image sensing nodes that define them, are perfectly aligned at FIG. 3B in that there is a center-point corresponding to a node of one array exactly centered among four adjacent center-points corresponding to four nodes of the other array. Overlap of the portion of the scene captured by adjacent center-points is minimized, and therefore the resolution which can be achieved by the super resolution software that integrates all the information captured by both arrays is maximized. This is the ideal.

FIG. 3C illustrates similar to FIG. 3B but for a practical commercial imaging system that is subject to manufacturing error. The center-points of image sensing nodes of one array are not centrally disposed among adjacent center-points corresponding to nodes of the other array. If one were to image circles of focus centered on each of the solid + center-points, there would be substantial overlap with circles centered on each of the dashed + center-points. This overlap represents generally the loss in resolution caused by the mis-aligned arrays of image sensing nodes, as compared to resolution which could be achieved by the super resolution software if the arrays were perfectly aligned as in FIG. 3B.

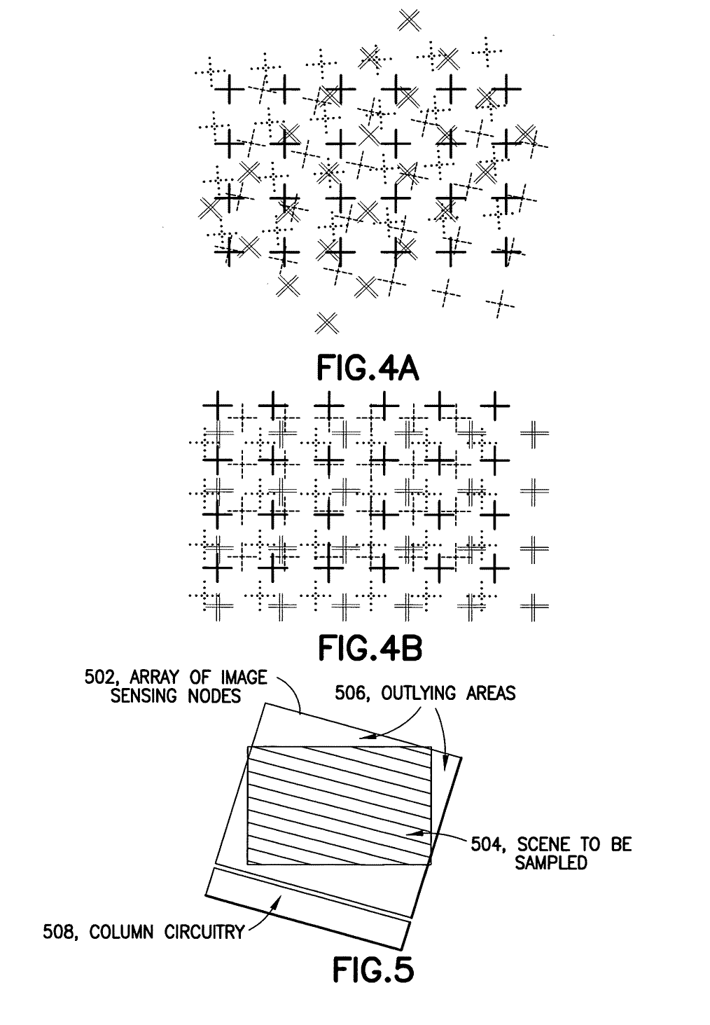

FIGS. 4A-B illustrate two different embodiments of the invention which illustrate center-points on a scene corresponding to image sensing nodes of four different arrays. FIG. 4A illustrates an embodiment in which the four arrays are rotated relative to one another. FIG. 4B illustrates an embodiment in which the size of the portion imaged by the image sensing nodes differs for each of the four arrays. These embodiments can be combined (e.g., different size and rotated as compared to another array of image sending nodes), and the number of image sensing arrays may be any number greater than one.

Consider FIG. 4A. Center-points corresponding to image sensing nodes of the four different arrays are distinguished by solid + mark, dashed + mark, dotted + mark, and double-line + mark. Consider the solid + marks as corresponding to a first array of image sensing nodes, which we conveniently use as a reference orientation. A second array of image sensing nodes designed by the dashed + marks is rotated clockwise approximately 30 degrees as compared to the first array. A third array of image sensing nodes designed by the double-line + marks is rotated counter-clockwise approximately 45 degrees as compared to the first array.

A fourth array of image sensing nodes designed by the dotted + marks is oriented the same as the first array (rows and columns are parallel as between those two arrays) and the pixel sizes as illustrated appear to be the same (the size of the circle which is the portion of the scene that one pixel captures). In fact, they differ slightly as will be appreciated by an example below in which one pixel size is 0.9 units and another pixel size is 1.1 units. Note that the dashed + center-points of the fourth array in the FIG. 4A embodiment are not perfectly aligned (e.g., aligned to maximize their combined resolution, see FIG. 3B) with the solid + center-points of the first array. While similar mis-alignment at FIG. 3C was an unintended consequence of manufacturing imprecision, at FIG. 4A it is a purposeful mis-alignment as between the first array and the fourth array because whether or not the first and fourth arrays are perfectly aligned or mis-aligned, both the second array (dashed + center-points) and the third array (double-line + center-points) are rotated relative to them both.

Now consider FIG. 4B. Center-points of the four arrays of image sensing nodes are similarly distinguished by solid, dashed, dotted and double-line + marks. The orientation of the image sensing nodes of these four arrays are not rotated relative to one another, but instead FIG. 4B illustrates that the individual image sensing nodes of the different arrays capture a different size of the scene being imaged, as compared to nodes in other arrays.

Using the same convention as in FIG. 4A for first, second, third and fourth arrays, individual image sensing nodes corresponding to the solid + marks of the first array capture a portion of the scene that is a first size. As is known in the photography arts, this size may be objectively measured using a circle of confusion CoC diameter limit, which is often used to calculate depth of field. There are different ways to find the CoC diameter limit, for example the Zeiss formula [d/1730] or [anticipated viewing distance (cm)/desired resolution (lines/mm) for a 25 cm viewing distance/anticipated enlargement factor/25] (where 25 cm viewing distance is used as the standard for the closest comfortable viewing distance at which a person with good vision can usually distinguish an image resolution of 5 line pairs per millimeter (equivalent to a CoC diameter limit of 0.2 mm in the final image).

Individual image sensing nodes of the second array, which correspond to the dashed + marks at FIG. 4B, capture a portion of the scene that is a second size, in this example smaller than the first size. Individual image sensing nodes of the third array, which correspond to the double-line + marks at FIG. 4B, capture a portion of the scene that is a third size, in this example larger than the first size. Finally, individual image sensing nodes of the fourth array, which correspond to the dotted + marks at FIG. 4B, capture a portion of the scene that is a fourth size, in this example nearly the same size as the first size. Image sensing nodes of each of the first array (solid + center-points), the second array (dashed + center-points), the third array (double-line + center-points), and the fourth array (dotted + center-points) of FIG. 4B capture a different size portion of the image as compared to nodes in any of the other four arrays in FIG. 4B.

From the examples at FIGS. 4A-B it is clear that embodiments of the invention set the image sensing nodes so that the sampling at the scene being imaged is “randomized” regardless of the alignment of the individual sensors. In one implementation the image sensing nodes (or the entire array of them) are rotated. This rotation can be slight or significant, and the 30 and 45 degree rotations at FIG. 4A are both considered significant rotations. This rotation changes the orientation of the image sending node so that its corresponding sampling at the scene being imaged occurs within a desired rectangular area even if the image sensing node is rotated.

As shown at FIG. 4B, different pixel sizes can also be used to randomize the sampling at the scene. These different sized pixels which capture different size portions of the scene being imaged may be disposed on different arrays or on the same array of image sensing nodes. In order to better randomize the different-size pixels, resolution from the super resolution algorithm that integrates the information from the different size pixels is maximized when the larger pixels are not simply integer multiple sizes over the smaller pixels. The following examples make this point clearly, and these examples assume for simplicity of the explanation that there are only two different size pixels in the imaging system, those pixels of a first size are in a first array pixels of a second size are in a second array.

Assume that the first size is 1 arbitrary unit. If the second size is 2 units, there are many integer values which yield the same results for both arrays: e.g., 2*1=1*2; 4*1=2*2; 6*1=3*2, etc. This is a poor design from the perspective of increasing resolution regardless of nodes that are not perfectly aligned.

If instead the first size is 1.5 arbitrary units while the second size is 2 units, then there are still many integer values which yield the same result as these two arrays: e.g., 4*1.5=3*2; 8*1.5=6*2; 12*1.5=9*2; etc. There are fewer solutions than in the first example so the design is a bit improved, but not yet sufficiently good.

For a third example, assume that the first size is 0.9 arbitrary units while the second size is 1.1 units. In this case there are very few integer values which yield the same result as both arrays. One example is 33*0.9=27*1.1, but since there are relatively few occurrences for this size disparity this design is a better choice than either of the previous two examples.

As noted above, the rotation of image sensing nodes may also be used in combination with using nodes that capture different size portions of the scene being imaged. Varies the sampling even more than either one option alone.

Once the sensors are properly disposed, whether rotated relative to one another and/or different pixel sizes, then by calibrating the super resolution algorithm the end result is an improved resolution for the final image as compared to what the prior art would produce under conditions of manufacturing mis-alignment of the pixels in different arrays. This calibration computes the exact location of each sampling pixel, which is simply done because the randomized sampling arises from the rotation or different size pixels to begin with. Clearly sometimes individual pixels that correspond to one another but from different arrays will still overlap in some embodiments. While this causes a localized drop in resolution (as compared to idealized alignment) at that point of overlap, it is an acceptable outcome because the randomized sampling mitigates the likelihood that portions of the scene will not be imaged at all. In the prior art, such un-sampled portions are filled in by smoothing software, but in fact it remains that there is no actual sampling at those smoothed over discontinuities. Embodiments of this invention accept a reasonable likelihood of overlap for a much reduced likelihood that there will be un-sampled portions of the scene.

This randomness of sampling can be readily implemented for digital film. A digital film system can be implemented as a lenslet camera and utilizing the same approach as detailed above for image capture on a CMOS or CCD hardware array. For the digital film embodiment, individual nodes of the digital film to which individual lenslets image corresponding portions of the scene are in the position of the hardware nodes of the above CMOS or CCD implementations.

FIG. 5 illustrates two examples of how a rotated array embodiment of the invention can be implemented in practice. At FIG. 5 there is shown one sensor array 502, which by example is rotated relative to another array. For convenience we assume that other array is aligned with the Cartesian x-y axes of the overall FIG. 5 drawing (e.g. the illustrated array 502 has about a 30 degree clockwise rotation). The area to be imaged, the scene, is shown at FIG. 5 as 504. In a first implementation, the entire sensor array is active but less than all image sensing nodes of the array actually capture any portion of the scene 504. Any information captured at pixels within the outlying sections 506 is filtered out and only those pixels that capture a portion of the scene itself are integrated with information captured by the other array. If the other sensor (not shown) is matched equally to the scene 504, then clearly this sensor 504 shown at FIG. 5 has a larger optical format than the one not shown.

In another implementation shown at FIG. 5, the parallel slanted lines shown within the outline of the scene 504 represent all the pixels which are active in the overall sensor array 502. In this implementation the sensor 502 is considered to have varying line length; individual pixels/sensor nodes of any individual row can be selectively made active or not active for capturing a particular image 504. Of course, entire rows or columns can be shut off also. In this implementation, the readout circuitry for the columns, shown as 508 in FIG. 5, receives information only from the active pixels which are shown in FIG. 5 by the parallel slanted lines. All pixels in the outlying areas 506 are not active and so provide no signal that needs to be filtered.

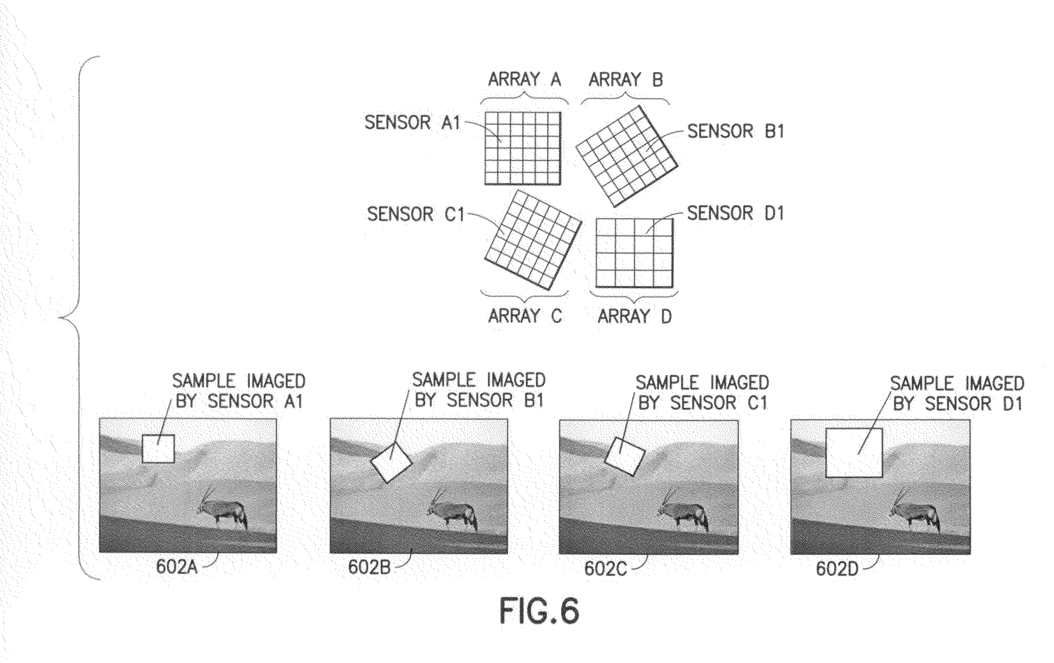

FIG. 6 illustrates an overview of four sensor arrays disposed according to an exemplary embodiment of these teachings and a scene for which corresponding nodes of the arrays sample corresponding portions. The four sensor arrays or modules A, B, C and D are arranged in the host device/imaging system substantially as shown at FIG. 6: adjacent to and separate from one another. Each square in each array is an individual image sensing node. There is also an array of lenslets (not shown) between the illustrated arrays A, B, C, D and the viewer, so that each lenslet directs light to one (or more) of the image sensing nodes. In this example embodiment there is a different lenslet array for each sensor array.

Nodes in array A are oriented with the page and are used as an arbitrary reference orientation and size. Nodes in array B are rotated about 50 degrees relative to nodes in array A. Nodes in array C are rotated about 25 degrees relative to nodes in array A. Nodes in array D capture a larger size portion of the scene (larger pixel size) as compared to nodes in array A. Optionally, array D may be also rotated with respect to array A.

For convenience each rotated or different size node is shown as lying in a physically distinct substrate as compared to nodes of array A, but in an embodiment the different nodes may be disposed on the same substrate and nodes of one like-size or like-orientation array may be interspersed with nodes of a different like-size or like-orientation array. While this is relatively straightforward to do with different size nodes on a common substrate, from a manufacturing perspective it is anticipated to be a bit more costly to manufacture nodes with different rotation orientation on the same substrate, particularly for pixels in a CMOS implementation.

Shown are individual image sensing nodes A1 of array A, B1 of array B, C1 of array C and D1 of array D. These are corresponding nodes because they are positioned so as to capture a similar (at least partially overlapping) portion of the overall scene. At the lower portion of FIG. 6 is the scene which the imaging system captures simultaneously with its four sensor arrays. It is the same scene repeated four times for clarity of description; when the aperture is ‘opened’ (power applied to the CMOS or removed from the diodes) array A sees scene 602A, array B sees scene 602B, array C sees scene 602C and array D sees scene 602D. Node A1 captures the blanked portion of scene 602A; node B1 captures the blanked portion of scene 602B, node C1 captures the blanked portion of scene 602C, and node D1 captures the blanked portion of scene 602D. It is understood these portions being captured by the single image sensing nodes are exaggerated in size for purposes of describing the image capture. While there is overlap among the portions captured by the four illustrated sensors, it is clear there is also some randomizing of the sampling across the scene and the different sensor orientation/size assures those captured portions/samples are not identical. Extended across all nodes of the different arrays, this randomizing assures a high likelihood that every portion of the scene will be captured at least once. The overlapping information is corrected in the super-resolution algorithm which is calibrated for the different sensor orientation and/or size, and the sensor orientation/size is fixed from the physical mounting of the arrays in the overall imaging system/host device.

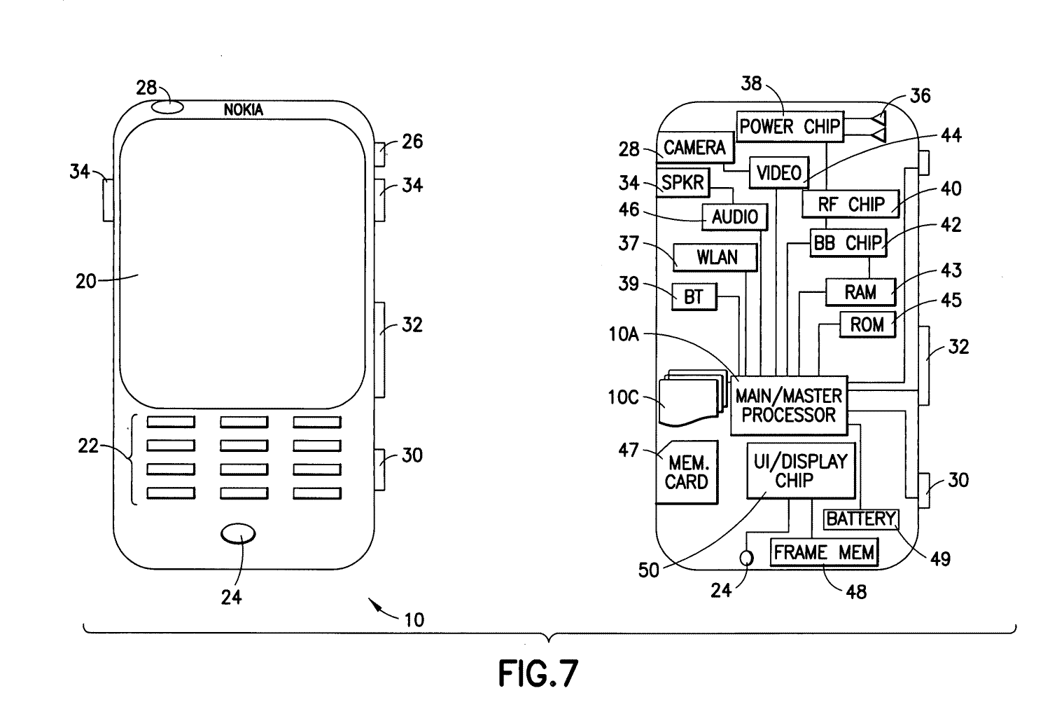

There are numerous host devices in which embodiments of the invention can be implemented. One example host imaging system is disposed within a mobile terminal/user equipment UE, shown in a non-limiting embodiment at FIG. 7. The UE 10 includes a controller, such as a computer or a data processor (DP) 10A, a computer-readable storage medium embodied as a memory that stores a program of computer instructions 10C, and one or more radio frequency (RF) transceivers for bidirectional wireless communications with other radio terminals and/or network nodes via one or more antennas.

At least one of the programs 10C and 12C is assumed to include program instructions that, when executed by the associated DP 10A, enable the apparatus 10 to operate in accordance with the exemplary embodiments of this invention, as detailed above by example. One such program 10C is the super resolution algorithm which calibrates and accounts for the different orientation and/or size of the nodes of the arrays. That is, the exemplary embodiments of this invention may be implemented at least in part by computer software executable by the DP 10A of the UE 10, or by a combination of software and hardware (and firmware).

In general, the various embodiments of the UE 10 can include, but are not limited to, cellular telephones, personal digital assistants (PDAs) or gaming devices having digital imaging capabilities, portable computers having digital imaging capabilities, image capture devices such as digital cameras, music storage and playback appliances having digital imaging capabilities, as well as portable units or terminals that incorporate combinations of such functions. Representative host devices need not have the capability, as mobile terminals do, of communicating with other electronic devices, either wirelessly or otherwise.

The computer readable memories as will be detailed below may be of any type suitable to the local technical environment and may be implemented using any suitable data storage technology, such as semiconductor based memory devices, flash memory, magnetic memory devices and systems, optical memory devices and systems, fixed memory and removable memory. The DP 10A may be of any type suitable to the local technical environment, and may include one or more of general purpose computers, special purpose computers, application specific integrated circuits, read-out integrated circuits, microprocessors, digital signal processors (DSPs) and processors based on a dual/multicore processor architecture, as non-limiting examples.

FIG. 7 details an exemplary UE 10 in both plan view (left) and sectional view (right), and the invention may be embodied in one or some combination of those more function-specific components. At FIG. 7 the UE 10 has a graphical display interface 20 and a user interface 22 illustrated as a keypad but understood as also encompassing touch-screen technology at the graphical display interface 20 and voice-recognition technology received at the microphone 24. The final image from the super-resolution algorithm may be displayed at the interface 20 and/or stored in a computer readable memory. A power actuator 26 controls the device being turned on and off by the user. The exemplary UE 10 includes an imaging system 28 which is shown as being forward facing (e.g., for video calls) but may alternatively or additionally be rearward facing (e.g., for capturing images and video for local storage). The imaging system/camera 28 is controlled by a shutter actuator 30 and optionally by a zoom actuator 32 which may alternatively function as a volume adjustment for speaker(s) 34 when the imaging system 28 is not in an active mode. As above, within the imaging system 28 are a plurality of arrays of image sensing nodes and at least one array of lenslets corresponding to those nodes.

Within the sectional view of FIG. 7 there are multiple transmit/receive antennas 36 that are typically used for cellular communication. The antennas 36 may be multi-band for use with other radios in the UE. The operable ground plane for the antennas 36 is shown by shading as spanning the entire space enclosed by the UE housing though in some embodiments the ground plane may be limited to a smaller area, such as disposed on a printed wiring board on which the power chip 38 is formed. The power chip 38 controls power amplification on the channels being transmitted and/or across the antennas that transmit simultaneously where spatial diversity is used, and amplifies the received signals. The power chip 38 outputs the amplified received signal to the radio-frequency (RF) chip 40 which demodulates and downconverts the signal for baseband processing. The baseband (BB) chip 42 detects the signal which is then converted to a bit-stream and finally decoded. Similar processing occurs in reverse for signals generated in the apparatus 10 and transmitted from it.

Signals to and from the imaging system 28 pass through an image/video processor 44 which encodes and decodes the various image frames. The read-out circuitry is in one embodiment one with the image sensing nodes and in another embodiment is within the image/video processor 44. In an embodiment the image/video processor executes the super resolution algorithm. A separate audio processor 46 may also be present controlling signals to and from the speakers 34 and the microphone 24. The graphical display interface 20 is refreshed from a frame memory 48 as controlled by a user interface chip 50 which may process signals to and from the display interface 20 and/or additionally process user inputs from the keypad 22 and elsewhere.

Also shown for completeness are secondary radios such as a wireless local area network radio WLAN 37 and a Bluetooth® radio 39. Throughout the apparatus are various memories such as random access memory RAM 43, read only memory ROM 45, and in some embodiments removable memory such as the illustrated memory card 47 on which the various programs 10C are stored. The super resolution algorithm program may be stored on any of these individually, or in an embodiment is stored partially across several memories. All of these components within the UE 10 are normally powered by a portable power supply such as a battery 49.

The aforesaid processors 38, 40, 42, 44, 46, 50, if embodied as separate entities in a UE 10, may operate in a slave relationship to the main processor 10A, which then is in a master relationship to them. Any or all of these various processors of FIG. 7 access one or more of the various memories, which may be on-chip with the processor or separate therefrom. Note that the various chips (e.g., 38, 40, 42, 44 etc.) that were described above may be combined into a fewer number than described and, in a most compact case, may all be embodied physically within a single chip.

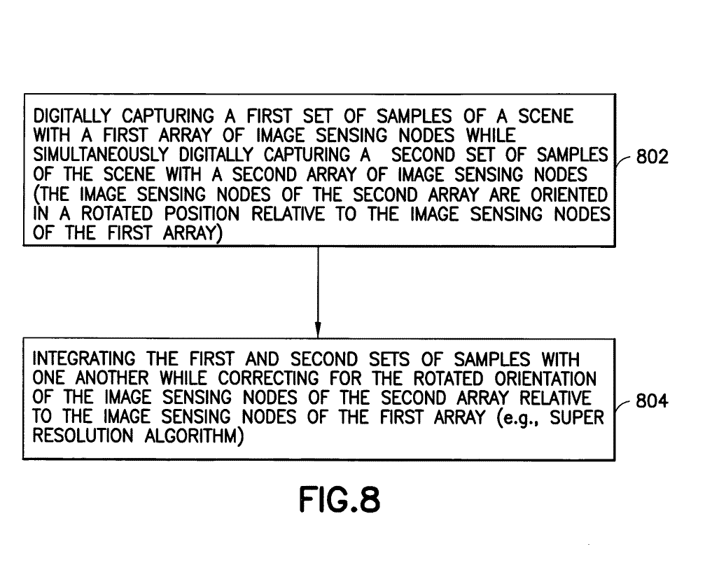

FIG. 8 is a logic flow diagram that illustrates the operation of a method, and a result of execution of computer program instructions, in accordance with the exemplary embodiments of this invention. In accordance with these exemplary embodiments a method performs, at block 802, a step of digitally capturing a first set of samples of a scene with a first array of image sensing nodes while simultaneously digitally capturing a second set of samples of the scene with a second array of image sensing nodes. The image sensing nodes of the second array are oriented in a rotated position relative to the image sensing nodes of the first array. An example of such a rotation is shown as between any pair of arrays in FIG. 6 except the pair array A with array D.

Further at block 804 there is the step of integrating the first and second sets of samples with one another while correcting for the rotated orientation of the image sensing nodes of the second array relative to the image sensing nodes of the first array. This is done by the super resolution algorithm which accounts for the different relative orientations. What is eventually output is a high resolution image, high resolution meaning a resolution higher than is output from any one of the first or second arrays alone.

As detailed above the image sensing nodes may be pixels of a complementary metal-oxide semiconductor device, or diodes of a charge coupled device.

There may also be a third set of samples of the scene which are digitally captured with a third array of image sensing nodes, in which each image sensing node of the third array samples a different size portion of the scene as compared to the image sensing nodes of the first array. In this case the third set of samples is also integrated with the first and second sets of samples. In a particular CMOS embodiment, this is a larger pixel size at the third array as compared to the first array.

In one embodiment, each image sensing node of the second array samples a different size portion of the scene as compared to the image sensing nodes of the first array. This is a combination of the relative rotation orientation plus different size portion sampling. Whether combined with rotation orientation or not, in an embodiment the different size portions of the scene that make up the third set of samples (from the third array) is not an integer multiple of the size of the portions of the scene that make up the first set of samples (from the first array).

For an embodiment in which there are a total of N arrays of image sensing nodes, then N sets of samples of a scene are digitally captured with the N arrays of image sensing nodes, in which no pair of the N arrays exhibit both a same rotational orientation and a same portion size of the scene sampled by corresponding image sensing nodes. In this embodiment N is an integer at least equal to three, and FIG. 6 illustrates just such an embodiment where N is equal to four.

In another embodiment detailed with respect to FIG. 5, all image sensing nodes of the first array are used to capture the first set of samples of the scene and only some of the image sensing nodes of the second array are used to capture the second set of samples, and the second array defines a larger optical format than the first array. Information output from nodes in the outlying areas are filtered out from the integrating to the high resolution image. In another embodiment of FIG. 5, some of the image sensing nodes of the second array are individually actuated for digitally capturing the second set of samples. In this instance all of the active nodes contribute to the integrated high resolution image, since no active node provides an output signal that is filtered out; all nodes in the outlying areas are not active.

The various blocks shown in FIG. 8 and the more detailed implementations immediately above may be viewed as method steps, and/or as operations that result from operation of computer program code, and/or as a plurality of coupled logic circuit elements constructed to carry out the associated function(s).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the exemplary embodiments of this invention may be illustrated and described as block diagrams, flow charts, or using some other pictorial representation, it is well understood that these blocks, apparatus, systems, techniques or methods described herein may be implemented in, as nonlimiting examples, hardware, software, firmware, special purpose circuits or logic, general purpose hardware or controller or other computing devices, or some combination thereof.

It should thus be appreciated that at least some aspects of the exemplary embodiments of the inventions may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

Various modifications and adaptations to the foregoing exemplary embodiments of this invention may become apparent to those skilled in the relevant arts in view of the foregoing description, when read in conjunction with the accompanying drawings. However, any and all modifications will still fall within the scope of the non-limiting and exemplary embodiments of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of the various non-limiting and exemplary embodiments of this invention may be used to advantage without the corresponding use of other features. As such, the foregoing description should be considered as merely illustrative of the principles, teachings and exemplary embodiments of this invention, and not in limitation thereof.

1. A method comprising:
digitally capturing a first set of samples of a scene with a first array of image sensing nodes while simultaneously digitally capturing a second set of samples of the scene with a second array of image sensing nodes,
in which the image sensing nodes of the second array are oriented in a rotated position relative to the image sensing nodes of the first array; and
integrating the first and second sets of samples with one another while correcting for the rotated orientation of the image sensing nodes of the second array relative to the image sensing nodes of the first array and outputting a high resolution image.

2. The method according to claim 1, in which the image sensing nodes comprise one of pixels of a complementary metal-oxide semiconductor device or diodes of a charge coupled device.

3. The method according to claim 1, in which digitally capturing further comprises simultaneously digitally capturing a third set of samples of the scene with a third array of image sensing nodes,
in which each image sensing node of the third array samples a different size portion of the scene as compared to the image sensing nodes of the first array;
and in which integrating comprising integrating the third set of samples with the first and second sets of samples.

4. The method according to claim 1, in which each image sensing node of the second array samples a different size portion of the scene as compared to the image sensing nodes of the first array.

5. The method according to claim 3, in which the different size portions of the scene of the third set of samples is not an integer multiple of the size of the portions of the scene of the first set of samples.

6. The method according to claim 1, in which digitally capturing comprises simultaneously digitally capturing N sets of samples of a scene with N arrays of image sensing nodes, in which no pair of the N arrays exhibit both a same rotational orientation and a same portion size of the scene sampled by corresponding image sensing nodes, wherein N is an integer at least equal to three.

7. The method according to claim 1, in which all image sensing nodes of the first array are used to capture the first set of samples of the scene and only some of the image sensing nodes of the second array are used to capture the second set of samples, and the second array defines a larger optical format than the first array.

8. The method according to claim 1, in which all image sensing nodes of the first array are used to capture the first set of samples of the scene and only some of the image sensing nodes of the second array are used to capture the second set of samples, and the said some of the image sensing nodes of the second array are individually actuated for digitally capturing the second set of samples.

9. An apparatus comprising:
a first array of image sensing nodes;
a second array of image sensing nodes oriented in a rotated position relative to the image sensing nodes of the first array;
at least one array of lenslets disposed to direct light from external of the apparatus toward the first and second arrays;
a memory storing a program that integrates outputs of the first and second arrays to a high resolution image while correcting for the rotated orientation of the image sensing nodes of the second array relative to the image sensing nodes of the first array; and
at least one processor configured to execute the stored program on outputs of the first and second arrays.

10. The apparatus according to claim 9, in which the image sensing nodes comprise one of pixels of a complementary metal-oxide semiconductor device or diodes of a charge coupled device.

11. The apparatus according to claim 9, further comprising a third array of image sensing nodes,
in which each image sensing node of the third array is configured to sample a different size portion of a scene external of the apparatus as compared to the image sensing nodes of the first array;
and in which the program integrates outputs of the first and second and third arrays to the high resolution image.

12. The apparatus according to claim 9, in which each image sensing node of the second array is configured to samples a different size portion of a scene external of the apparatus as compared to the image sensing nodes of the first array.

13. The apparatus according to claim 11, in which the different size portions of the scene sampled by the image sensing nodes of the third array is not an integer multiple of the size of the portions of the scene sampled by the image sensing nodes of the first array.

14. The apparatus according to claim 9, in which the apparatus comprises a total of N arrays of image sensing nodes, in which no pair of the N arrays exhibit both a same rotational orientation and a same portion size of the scene sampled by corresponding image sensing nodes, wherein N is an integer at least equal to three.

15. The apparatus according to claim 9, in which the second array defines a larger optical format than the first array.

16. The apparatus according to claim 9, in which the processor is configured to individually actuate image sensing nodes of the second array.

17. A computer readable memory storing a program of instructions that when executed by a processor result in actions comprising:
digitally capturing a first set of samples of a scene with a first array of image sensing nodes while simultaneously digitally capturing a second set of samples of the scene with a second array of image sensing nodes,
in which the image sensing nodes of the second array are oriented in a rotated position relative to the image sensing nodes of the first array; and
integrating the first and second sets of samples with one another while correcting for the rotated orientation of the image sensing nodes of the second array relative to the image sensing nodes of the first array and outputting a high resolution image.

18. The computer readable memory according to claim 17, in which the image sensing nodes comprise one of pixels of a complementary metal-oxide semiconductor device or diodes of a charge coupled device.

19. The computer readable memory according to claim 17, in which digitally capturing further comprises simultaneously digitally capturing a third set of samples of the scene with a third array of image sensing nodes,
in which each image sensing node of the third array samples a different size portion of the scene as compared to the image sensing nodes of the first array;
and in which integrating comprising integrating the third set of samples with the first and second sets of samples.

20. The computer readable memory according to claim 17, in which each image sensing node of the second array samples a different size portion of the scene as compared to the image sensing nodes of the first array.
